(19) United States
(12) Patent Application Publication
(10) Pub. No.: US 2012/0331313 A1
(43) Pub. Date: Dec. 27, 2012

(54) IMAGE FORMING APPARATUS, POWER SUPPLY CONTROL METHOD, AND COMPUTER-READABLE STORAGE MEDIUM

(75) Inventor: Taichi YOSHIOKA, Kanagawa (JP)

(73) Assignee: RICOH COMPANY, LIMITED, Tokyo (JP)

(21) Appl. No.: 13/489,569

(22) Filed: Jun. 6, 2012

(30) Foreign Application Priority Data
Jun. 24, 2011 (JP) 2011-140400

(51) Int. Cl. G06F 1/26

(52) U.S. Cl. 713/300

(57) ABSTRACT

An image forming apparatus includes a main power supply; a power generation unit configured to generate electric power with natural energy; a secondary battery configured to serve as a power supply source while the electric power is not supplied from the main power supply, the secondary battery being charged with the electric power generated by the power generation unit; a voltage detector configured to detect an output voltage of the secondary battery; and a switching unit configured to switch the power supply source from the secondary battery to the main power supply when the output voltage becomes equal to or lower than a first threshold, and switch the power supply source from the main power supply to the secondary battery when the output voltage becomes equal to or higher than a second threshold that is higher than the first threshold.

### CROSS-REFERENCE TO RELATED APPLICATIONS

The present application claims priority to and incorporates by reference the entire contents of Japanese Patent Application No. 2011-140400 filed in Japan on Jun. 24, 2011.

### BACKGROUND OF THE INVENTION

1. Field of the Invention

The present invention relates to an image forming apparatus, a power supply control method, and a computer-readable storage medium.

2. Description of the Related Art

Conventionally, image forming apparatuses including a secondary battery as a power supply source have been proposed. The secondary battery is charged with electric power generated by a power generation unit such as a solar cell. Such an image forming apparatus is designed to reduce electric power consumption by blocking the main power supply and supplying electric power to an apparatus main body from the secondary battery in an energy saving mode.

In the image forming apparatus of this type, if a state of charge (SOC) of the secondary battery is lowered significantly due to discharge in the energy saving mode, there arises a risk that electric power cannot be supplied appropriately. Then, a power supply control technique as described in Japanese Patent No. 4365052 has been proposed, for example. In the technique as described in Japanese Patent No. 4365052, if an output voltage of a secondary battery drops to be equal to or lower than a predetermined threshold in the energy saving mode, the power supply source is switched from the secondary battery to the main power supply. Thereafter, if the SOC of the secondary battery is recovered by getting a charge of electric power generated by the power generation unit and the output voltage of the secondary battery becomes higher than the threshold, the power supply source is switched from the main power supply to the secondary battery.

However, in this conventional technique, the threshold for switching the power supply source from the secondary battery to the main power supply is equal to the threshold for switching the power supply source from the main power supply to the secondary battery. Therefore, if the threshold is defined to be lower with reference to the lowest level of SOC that makes it possible to supply electric power appropriately, when the power supply source is switched from the main power supply to the secondary battery, the secondary battery starts discharging in a state where the SOC thereof is not sufficient so that the output voltage drops drastically to be equal to or lower than the threshold soon. As a result, the power supply source is switched frequently and electric power is consumed wastefully. On the other hand, if the threshold is defined to be higher with reference to a sufficient SOC under which the voltage immediately after the start of discharge does not drop drastically, time during which electric power is supplied from the secondary battery becomes shorter, resulting in an increase in electric power consumption.

Therefore, there is a need for an image forming apparatus and a power supply control method that can ensure time during which electric power is supplied from a secondary battery sufficiently while effectively preventing frequent switching of power supply sources so as to reduce electric power consumption appropriately.

### SUMMARY OF THE INVENTION

It is an object of the present invention to at least partially solve the problems in the conventional technology.

According to an embodiment, there is provided an image forming apparatus that includes a main power supply configured to receive electric power from a commercial power supply; a power generation unit configured to generate electric power with natural energy; a secondary battery configured to serve as a power supply source while the electric power is not supplied from the main power supply, the secondary battery being charged with the electric power generated by the power generation unit; a voltage detector configured to detect an output voltage of the secondary battery; and a switching unit configured to switch the power supply source from the secondary battery to the main power supply when the output voltage becomes equal to or lower than a first threshold while the electric power is supplied from the secondary battery, and switch the power supply source from the main power supply to the secondary battery when the output voltage becomes equal to or higher than a second threshold that is higher than the first threshold while the electric power is supplied from the main power supply. The second threshold is set such that the output voltage, when the second battery has not been charged and a set time has passed after the power supply source is switched from the main power supply to the secondary battery, is higher than the first threshold.

According to another embodiment, there is provided a power supply control method performed in an image forming apparatus that includes a main power supply configured to receive electric power from a commercial power supply, a power generation unit configured to generate electric power with natural energy, and a secondary battery configured to serve as a power supply source while the electric power is not supplied from the main power supply, the secondary battery being charged with the electric power generated by the power generation unit. The power supply control method includes detecting an output voltage of the secondary battery; switching the power supply source from the secondary battery to the main power supply when the output voltage becomes equal to or lower than a first threshold while the electric power is supplied from the secondary battery; switching the power supply source from the main power supply to the secondary battery when the output voltage becomes equal to or higher than a second threshold that is higher than the first threshold while the electric power is supplied from the main power supply. The second threshold is set such that the output voltage, when the second battery has not been charged and a set time has passed after the power supply source is switched from the main power supply to the secondary battery, is higher than the first threshold.

According to still another embodiment, there is provided a non-transitory computer-readable storage medium with an executable program stored thereon and performed in an image forming apparatus that includes a main power supply configured to receive electric power from a commercial power supply, a power generation unit configured to generate electric power with natural energy, and a secondary battery configured to serve as a power supply source while the electric power is not supplied from the main power supply, the secondary battery being charged with the electric power generated by the power generation unit. The program instructs a processor of the image forming apparatus to perform detecting an output voltage of the secondary battery; switching the power supply source from the secondary battery to the main power supply when the output voltage becomes equal to or lower than a first threshold while the electric power is supplied from the secondary battery; switching the power supply source from the main power supply to the secondary battery when the output voltage becomes equal to or higher than a second threshold that is higher than the first threshold while the electric power is supplied from the main power supply. The second threshold is set such that the output voltage, when the second battery has not been charged and a set time has passed after the power supply source is switched from the main power supply to the secondary battery, is higher than the first threshold.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a hardware configuration of an image forming apparatus, and a view illustrating inner configurations of an engine unit and a controller unit included in the image forming apparatus;

FIG. 2 is a block diagram illustrating a hardware configuration of the image forming apparatus, and a view illustrating an inner configuration of a power supply unit included in the image forming apparatus;

FIG. 3 is a view for explaining a relationship between change of an output voltage of a secondary battery and power supply control in an energy saving mode;

FIG. 4 is a view for explaining a state of electric power supply to the controller unit in a period 1 in FIG. 3;

FIG. 5 is a view for explaining a state of electric power supply to the controller unit in a period 2 in FIG. 3;

FIG. 6 is a view for explaining a state of electric power supply to the controller unit in a period 3 in FIG. 3;

FIG. 7 is a view for explaining a relationship between change of an output voltage of the secondary battery and power supply control in the energy saving mode; and

FIG. 8 is a graph illustrating an example of a discharge characteristic of the secondary battery.

### DETAILED DESCRIPTION OF THE PREFERRED EMBODIMENTS

Hereinafter, preferable embodiments of an image forming apparatus and a power supply control method according to the invention are described in detail with reference to accompanying drawings.

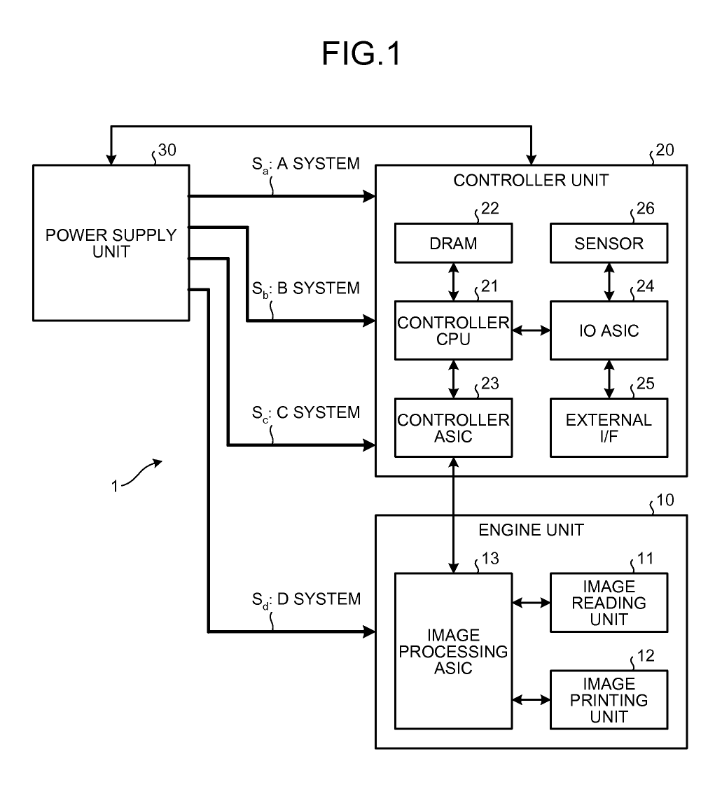

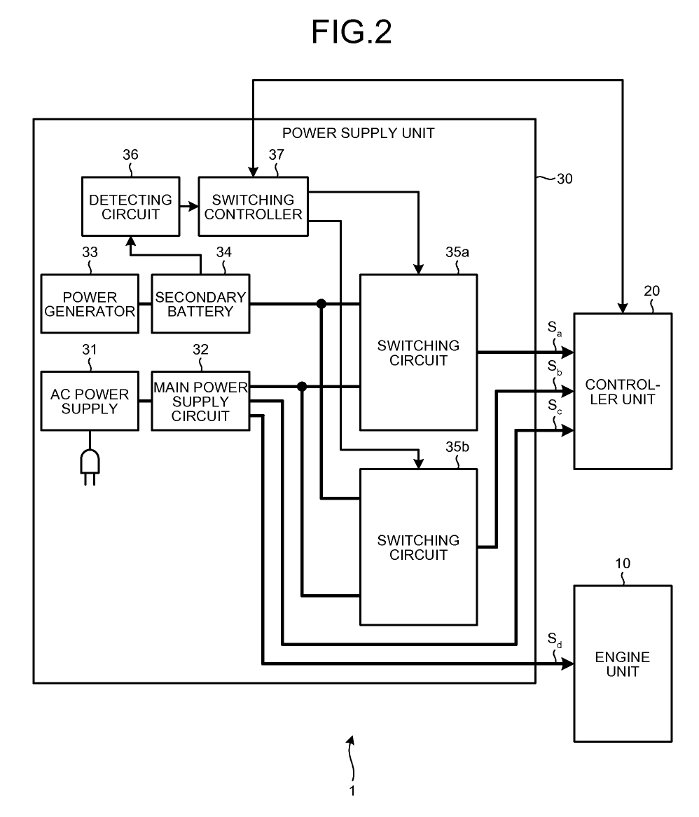

FIGS. 1 and 2 are block diagrams illustrating a hardware configuration of an image forming apparatus 1 according to the embodiment. FIG. 1 illustrates inner configurations of an engine unit 10 and a controller unit 20 included in the image forming apparatus 1. FIG. 2 illustrates an inner configuration of a power supply unit 30 included in the image forming apparatus 1.

The image forming apparatus 1 according to the embodiment includes the engine unit 10, the controller unit 20, and the power supply unit 30 as illustrated in FIGS. 1 and 2. The engine unit 10 performs reading of a document and printing of image data. The controller unit 20 controls operations of the image forming apparatus 1. The power supply unit 30 supplies electric power to the engine unit 10 and the controller unit 20. In the image forming apparatus 1 according to the embodiment, three systems of an A system Sₐ, a B system S_{b}, and a C system S_{c} are present as power supply systems from the power supply unit 30 to the controller unit 20. A power supply system from the power supply unit 30 to the engine unit 10 is a D system S_{d} only.

As illustrated in FIG. 1, the engine unit 10 includes an image reading unit 11, an image printing unit 12, and an image processing application specific integrated circuit (ASIC) 13. The image reading unit 11 acquires image data obtained by reading and computerizing a document. The image printing unit 12 prints image data on a print paper or the like. The image processing ASIC 13 performs various pieces of processing on the image data acquired by the image reading unit 11 and transmits the processed image data to the image printing unit 12.

In the image forming apparatus 1 according to the embodiment, electric power is supplied to the engine unit 10 from the power supply unit 30 with the power supply system of the D system S_{d}. When the operation mode of the image forming apparatus 1 is shifted to an energy saving mode, the power supply system of the D system S_{d} is blocked so that supply of electric power to the entire engine unit 10 is stopped.

As illustrated in FIG. 1, the controller unit 20 includes a controller central processing unit (CPU) 21, a dynamic random access memory (DRAM) 22, a controller ASIC 23, an In-Out (IO) ASIC 24, an external interface (I/F) 25, and a sensor 26. The controller CPU 21 controls the controller unit 20 entirely. The DRAM 22 is used as a work memory of the controller CPU 21. The controller ASIC 23 controls various pieces of image processing such as compression, decompression, and rotation of an image. The IO ASIC 24 controls input/output to the controller unit 20. The external I/F 25 is an interface for connecting an external PC on network such as a local area network (LAN).

In the image forming apparatus 1 according to the embodiment, electric power is supplied to the IO ASIC 24, the external I/F 25 and the sensor 26 of the controller unit 20 from the power supply unit 30 with the power supply systems of the A system Sₐ and the B system S_{b}. Furthermore, electric power is supplied to the controller CPU 21, the DRAM 22, and the controller ASIC 23 of the controller unit 20 from the power supply unit 30 with the power supply system of the C system S_{c}. When the operation mode of the image forming apparatus 1 is shifted to the energy saving mode, the power supply system of the C system S_{c} is blocked so that supply of electric power to the controller CPU 21, the DRAM 22, and the controller ASIC 23 of the controller unit 20 is stopped. On the other hand, even when the operation mode of the image forming apparatus 1 is shifted to the energy saving mode, the power supply systems of the A system Sₐ and the B system S_{b} are not blocked so that supply of electric power to the IO ASIC 24, the external I/F 25, and the sensor 26 of the controller unit 20 is continued. It is to be noted that the power supply system of the A system Sₐ is a power supply system of 3.3 V that is commonly used for a power supply voltage of an IC, for example. The power supply system of the B system S_{b} is a power supply system of 1.1 V that is commonly used for a core voltage of an IC, for example. It is to be noted that the classification of the power supply system is an example and can be varied variously. For example, the power supply system may be classified into much more power supply systems in one power supply voltage.

As illustrated in FIG. 2, the power supply unit 30 includes an AC power supply 31, a main power supply circuit 32, a power generator 33, a secondary battery 34, switching circuits 35a and 35b, a detecting circuit 36, and a switching controller 37.

The AC power supply 31 is a power supply to which electric power is supplied from a commercial power supply. The main power supply circuit 32 AC-DC-converts and DC-DC-converts the AC power supply 31 and generates a desired direct voltage (5 V, 24 V, 3.3 V, 1.1 V, or the like) so as to supply the direct voltage to the engine unit 10 and the controller unit 20.

The power generator 33 is a power generation module that generates electric power with natural energy such as light and heat. As the power generator 33, a solar cell or a thermoelectric conversion element is preferable, for example. It is to be noted that because the solar cell and the thermoelectric conversion element are power generation units that are widely known, they are not described in detail.

The secondary battery 34 is charged with electric power generated by the power generator 33. When the operation mode of the image forming apparatus 1 is shifted to the energy saving mode and electric power is not supplied from the main power supply circuit 32 to the engine unit 10 and the controller unit 20, the secondary battery 34 serves as a power supply source to the controller unit 20.

When the operation mode of the image forming apparatus 1 is the energy saving mode, the switching circuits 35a and 35b selectively switch the power supply source to the controller unit 20 between the main power supply circuit 32 and the secondary battery 34 under control by the switching controller 37. The switching circuit 35a switches the power supply source of the A system Sₐ and the switching circuit 35b switches the power supply source of the B system S_{b}. It is to be noted that when the power supply system to the controller unit 20 is classified into much more systems, a switching circuit is provided for each power supply system.

The detecting circuit 36 detects an output voltage of the secondary battery 34. The output voltage of the secondary battery 34 that is detected by the detecting circuit 36 is transmitted to the switching controller 37.

The switching controller 37 controls switching of the power supply sources to the controller unit 20 by the switching circuits 35a and 35b based on an operation mode notification signal from the controller unit 20 and the output voltage of the secondary battery 34 that has been detected by the detecting circuit 36.

To be more specific, if the switching controller 37 receives an operation mode notification signal indicating that the operation mode of the image forming apparatus 1 is shifted to the energy saving mode from the controller unit 20, the switching controller 37 operates the switching circuits 35a and 35b so as to switch the power supply sources of the A system Sₐ and the B system S_{b} to the controller unit 20 from the main power supply circuit 32 to the secondary battery 34. With this, electric power of the AC power supply 31 is not consumed, thereby achieving electric power consumption of 0 W.

Furthermore, if an output voltage of the secondary battery 34 becomes equal to or lower than an A system first threshold Vₜₕ₁_{_{—}}ₐ when electric power is supplied to the controller unit 20 from the secondary battery 34, the switching controller 37 operates the switching circuit 35a so as to switch the power supply source of the A system Sₐ to the controller unit 20 from the secondary battery 34 to the main power supply circuit 32.

Furthermore, after the power supply source of the A system Sₐ has been switched from the secondary battery 34 to the main power supply circuit 32, if the output voltage of the secondary battery 34 further lowers to be equal to or lower than a B system first threshold Vₜₕ₁_{_{—}}_{b}, the switching controller 37 operates the switching circuit 35b so as to switch the power supply source of the B system S_{b} from the secondary battery 34 to the main power supply circuit 32.

It is to be noted that in the embodiment, because the A system Sₐ is the power supply system of 3.3 V, the A system first threshold Vₜₕ₁_{_{—}}ₐ is a value around 3.3 V. Although the B system S_{b} is the power supply system of 1.1 V, because an output adjustable voltage of a lithium ion battery or the like that is commonly used as the secondary battery 34 is higher than 1.1 V, the B system first threshold Vₜₕ₁_{_{—}}_{b} is determined depending on the adjustable voltage of the secondary battery 34.

If the power supply sources of the A system Sₐ and the B system S_{b} to the controller unit 20 are switched from the secondary battery 34 to the main power supply circuit 32, the secondary battery 34 is charged with electric power generated by the power generator 33 and the SOC thereof is recovered. Therefore, the output voltage of the secondary battery 34 is gradually increased. Then, if the output voltage of the secondary battery 34 becomes equal to or higher than a B system second threshold Vₜₕ₂_{_{—}}_{b} that is higher than the B system first threshold Vₜₕ₁_{_{—}}_{b}, the switching controller 37 operates the switching circuit 35b so as to switch the power supply source of the B system S_{b} from the main power supply circuit 32 to the secondary battery 34.

Furthermore, after the power supply source of the B system S_{b} has been switched from the main power supply circuit 32 to the secondary battery 34, if the output voltage of the secondary battery 34 is further increased to be equal to or higher than an A system second threshold Vₜₕ₂_{_{—}}ₐ that is higher than the A system first threshold Vₜₕ₁_{_{—}}ₐ, the switching controller 37 operates the switching circuit 35a so as to switch the power supply source of the A system Sₐ from the main power supply circuit 32 to the secondary battery 34.

For the A system first threshold Vₜₕ₁_{_{—}}ₐ, the B system first threshold Vₜₕ₁_{_{—}}_{b}, the A system second threshold Vₜₕ₂_{_{—}}ₐ, and the B system second threshold Vₜₕ₂_{_{—}}_{b}, optimum values are selected by the controller unit 20 as an example. The selected values are notified to the switching controller 37 together with the operation mode notification signal. However, the A system first threshold Vₜₕ₁_{_{—}}ₐ, the B system first threshold Vₜₕ₁_{_{—}}_{b}, the A system second threshold Vₜₕ₂_{_{—}}ₐ, and the B system second threshold Vₜₕ₂_{_{—}}_{b} may be previously set to the switching controller 37. It is to be noted that a specific method of selecting the A system second threshold Vₜₕ₂_{_{—}}ₐ and the B system second threshold Vₜₕ₂_{_{—}}_{b} will be described in detail later.

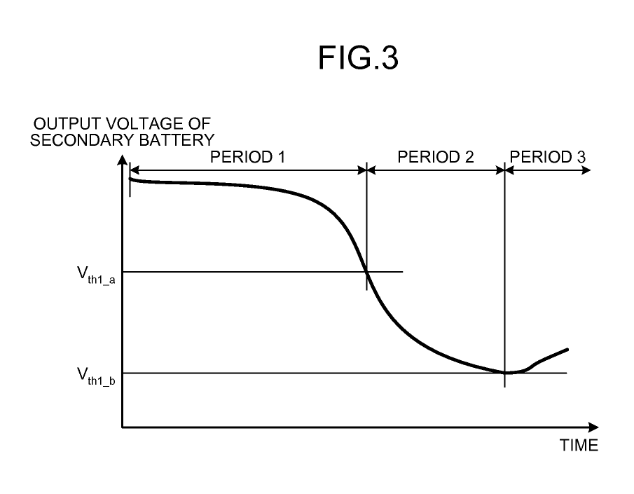

Next, power supply control when the image forming apparatus 1 is in the energy saving mode is described in detail with reference to FIGS. 3 to 7.

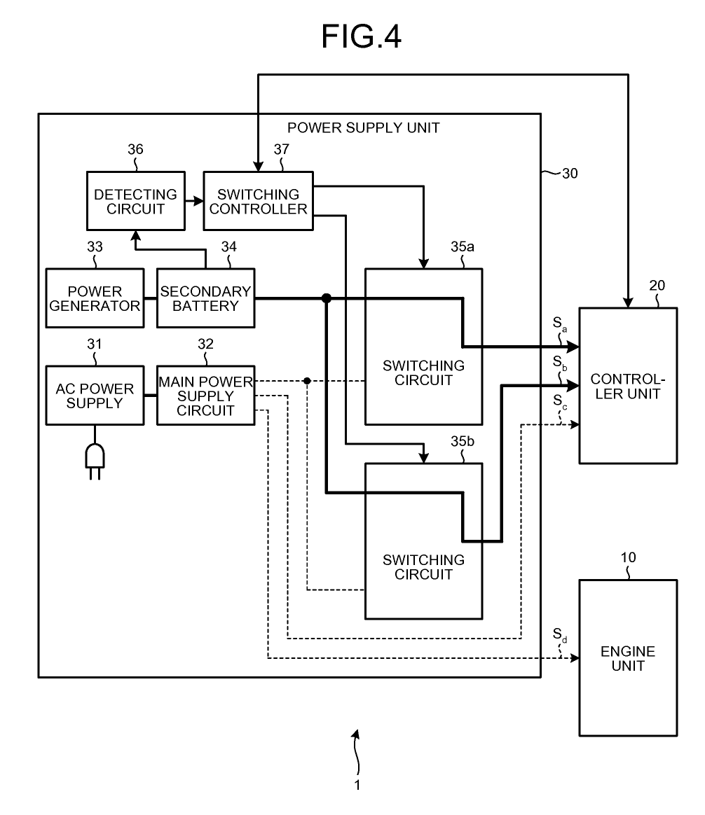

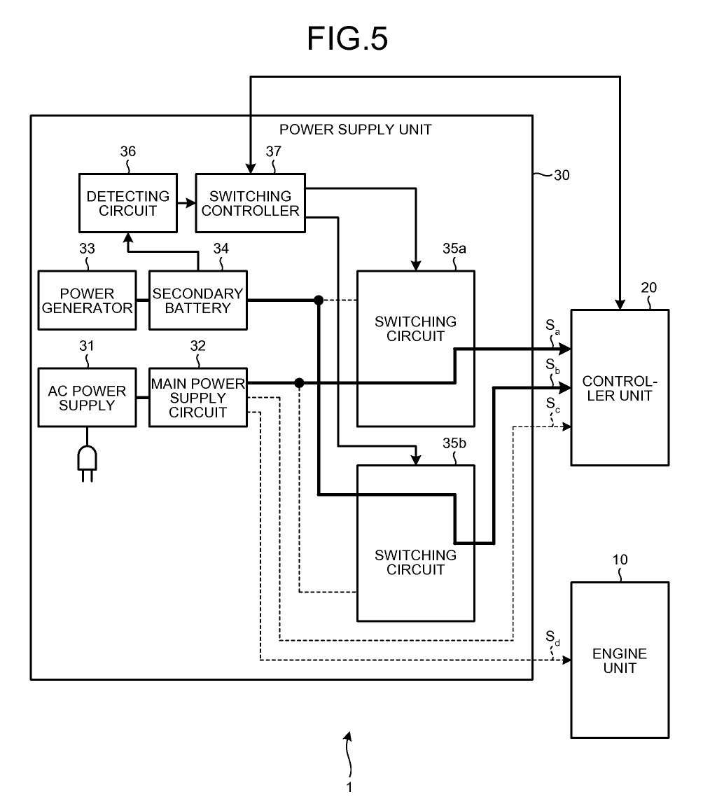

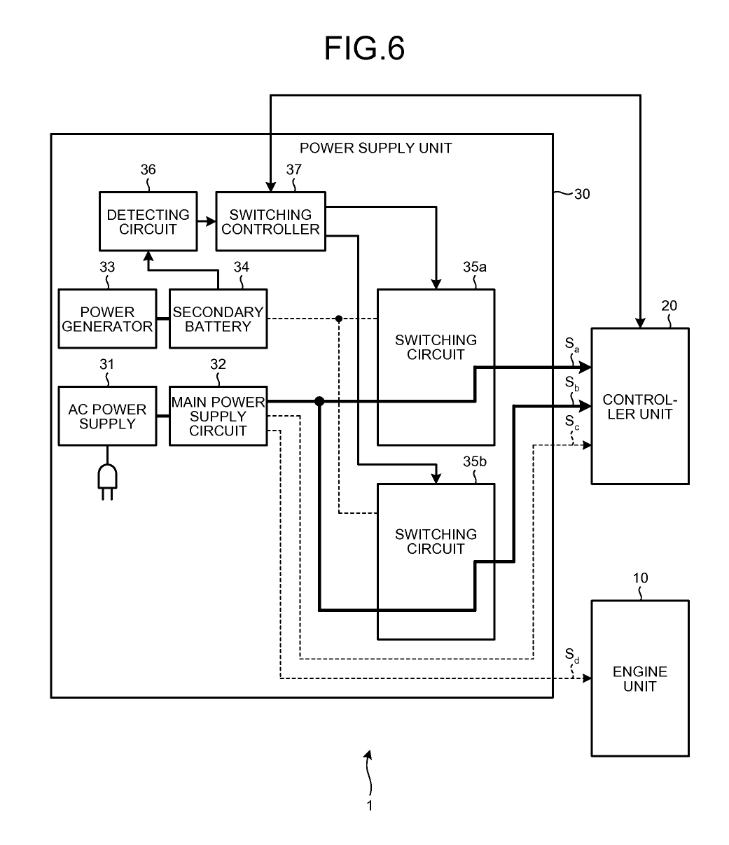

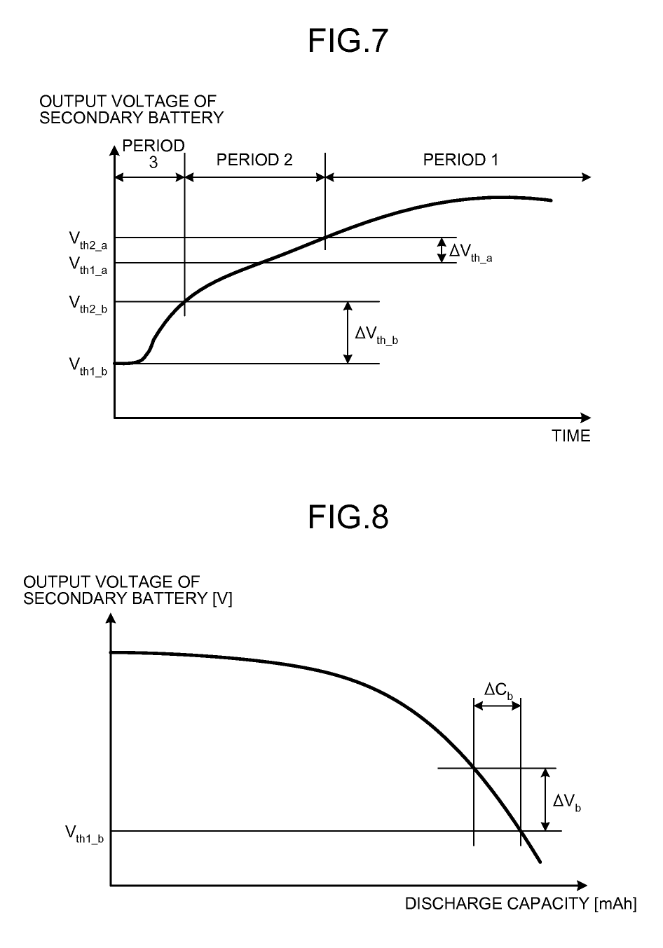

FIGS. 3 and 7 are views for explaining a relationship between change of an output voltage of the secondary battery 34 and power supply control in the energy saving mode. FIG. 4 is a view for explaining a state of electric power supply to the controller unit 20 in a period 1 in FIG. 3. FIG. 5 is a view for explaining a state of electric power supply to the controller unit 20 in a period 2 in FIG. 3. FIG. 6 is a view for explaining a state of electric power supply to the controller unit 20 in a period 3 in FIG. 3. Note that bold line arrows in FIGS. 4 to 6 indicate paths of electric power supply to the controller unit 20.

When the operation mode of the image forming apparatus 1 is shifted to the energy saving mode, the power supply sources of the A system Sₐ and the B system S_{b} to the controller unit 20 are switched from the main power supply circuit 32 to the secondary battery 34 as described above. With this, as illustrated in FIG. 4, a state where electric power is supplied to the controller unit 20 from the secondary battery 34 only is realized. Thereafter, as illustrated in FIG. 3, the output voltage of the secondary battery 34 gradually lowers with lowering of the SOC thereof due to discharge. However, the state where electric power is supplied to the controller unit 20 from the secondary battery 34 only (state in FIG. 4) is kept while the output voltage of the secondary battery 34 is higher than the A system first threshold Vₜₕ₁_{_{—}}ₐ (period 1 in FIG. 3).

Then, if the output voltage of the secondary battery 34 further lowers to be equal to or lower than the A system first threshold Vₜₕ₁_{_{—}}ₐ, the switching circuit 35a is operated under control by the switching controller 37 so that the power supply source of the A system Sₐ is switched from the secondary battery 34 to the main power supply circuit 32. With this, as illustrated in FIG. 5, a state where electric power is supplied to the controller unit 20 from both of the main power supply circuit 32 and the secondary battery 34 is realized. Thereafter, the state where electric power is supplied to the controller unit 20 from both of the main power supply circuit 32 and the secondary battery 34 (state in FIG. 5) is kept while the output voltage of the secondary battery 34 is higher than the B system first threshold Vₜₕ₁_{_{—}}_{b} (period 2 in FIG. 3).

Then, if the output voltage of the secondary battery 34 further lowers to be equal to or lower than the B system first threshold Vₜₕ₁_{_{—}}_{b}, the switching circuit 35b is operated under control by the switching controller 37 so that the power supply source of the B system S_{b} is switched from the secondary battery 34 to the main power supply circuit 32. With this, as illustrated in FIG. 6, a state where electric power is supplied to the controller unit 20 from the main power supply circuit 32 only is realized. Thereafter, if the secondary battery 34 is charged with electric power generated by the power generator 33 and the SOC thereof is recovered, the output voltage of the secondary battery 34 is gradually increased. However, the state where electric power is supplied to the controller unit 20 from the main power supply circuit 32 only (state in FIG. 6) is kept while the output voltage of the secondary battery 34 is lower than the B system second threshold Vₜₕ₂_{_{—}}_{b} as illustrated in FIG. 7 (period 3 in FIG. 3).

As described above, in the image forming apparatus 1 according to the embodiment, if the output voltage of the secondary battery 34 lowers with the lowering of the SOC thereof due to discharge of the secondary battery 34 in the energy saving mode, the power supply sources to the controller unit 20 are switched from the secondary battery 34 to the main power supply circuit 32 stepwisely in the A system Sₐ and the B system S_{b}. A threshold for the output voltage of the secondary battery 34 for switching the power supply source of the A system Sₐ from the secondary battery 34 to the main power supply circuit 32 corresponds to the A system first threshold Vₜₕ₁_{_{—}}ₐ. Furthermore, a threshold for the output voltage of the secondary battery 34 for switching the power supply source of the B system S_{b} from the secondary battery 34 to the main power supply circuit 32 corresponds to the B system first threshold Vₜₕ₁_{_{—}}_{b}.

If the power supply sources to the controller unit 20 are switched to the main power supply circuit 32 in both of the A system Sₐ and the B system S_{b}, the secondary battery 34 is charged with electric power generated by the power generator 33 and the SOC thereof is recovered. Then, if the SOC of the secondary battery 34 has been recovered sufficiently, the power supply sources to the controller unit 20 are switched from the main power supply circuit 32 to the secondary battery 34 in order to reduce electric power consumption in the energy saving mode. In this case, there arises the following problem if switching from the main power supply circuit 32 to the secondary battery 34 is performed using the thresholds (Vₜₕ₁_{_{—}}ₐ and Vₜₕ₁_{_{—}}_{b}) that are the same as those used in the switching from the secondary battery 34 to the main power supply circuit 32 as in the conventional technique.

For example, in a case of the B system S_{b}, if the power supply source of the B system S_{b} is switched from the main power supply circuit 32 to the secondary battery 34 immediately at a stage where the output voltage of the secondary battery 34 reaches the VVₜₕ₁_{_{—}}_{b}, the secondary battery 34 starts discharging in a state where the SOC thereof is not sufficient. Therefore, after the power supply source of the B system S_{b} has been switched from the main power supply circuit 32 to the secondary battery 34, the output voltage of the secondary battery 34 drops drastically to be equal to or lower than Vₜₕ₁_{_{—}}_{b} immediately. As a result, switching of the power supply sources of the B system S_{b} occurs frequently and electric power is consumed wastefully due to the frequent switching of the power supply sources.

On the other hand, when the Vₜₕ₁_{_{—}}_{b} is defined to be higher based on a sufficient SOC with which the voltage immediately after the discharge of the secondary battery 34 is started does not drop drastically, the above-described frequent switching of the power supply sources is prevented. However, in this case, the power supply source of the B system S_{b} is switched from the secondary battery 34 to the main power supply circuit 32 even in a state where electric power is sufficiently left on the secondary battery 34. Therefore, because time during which electric power can be supplied to the controller unit 20 from the secondary battery 34 in the energy saving mode becomes shorter, electric power consumption is increased.

In order to solve the above-described problem, in the image forming apparatus 1 according to the embodiment, the thresholds (A system second threshold Vₜₕ₂_{_{—}}ₐ and B system second threshold Vₜₕ₂_{_{—}}_{b}) when the power supply sources to the controller unit 20 are switched from the main power supply circuit 32 to the secondary battery 34 after the SOC of the secondary battery 34 has been recovered are defined to be larger than the thresholds (A system first threshold Vₜₕ₁_{_{—}}ₐ and B system first threshold Vₜₕ₁_{_{—}}_{b}) when the power supply sources are switched from the secondary battery 34 to the main power supply circuit 32. The electric power supply from the secondary battery 34 to the controller unit 20 is continued during a set time (A system set time ΔTₐ and B system set time ΔT_{b}).

A difference between the A system first threshold Vₜₕ₁_{_{—}}ₐ and the A system second threshold Vₜₕ₂_{_{—}}ₐ is assumed to be ΔVₜₕ_{_{—}}ₐ and a difference between the B system first threshold Vₜₕ₁_{_{—}}_{b} and the B system second threshold Vₜₕ₂_{_{—}}_{b} is assumed to be ΔVₜₕ_{_{—}}_{b}. Under the assumption, the A system second threshold Vₜₕ₂_{_{—}}ₐ and the B system second threshold Vₜₕ₂_{_{—}}_{b} can be expressed as follows.

Vₜₕ₂_{_{—}}ₐ=Vₜₕ₁_{_{—}}ₐ+ΔVₜₕ_{_{—}}ₐ

Vₜₕ₂_{_{—}}_{b}=Vₜₕ₁_{_{—}}_{b}+ΔVₜₕ_{_{—}}_{b}

If the secondary battery 34 is charged with electric power generated by the power generator 33 and the SOC thereof is recovered, the output voltage of the secondary battery 34 is gradually increased as illustrated in FIG. 7. However, the state where electric power is supplied to the controller unit 20 from the main power supply circuit 32 only (state in FIG. 6) is kept while the output voltage of the secondary battery 34 does not reach the B system second threshold Vₜₕ₂_{_{—}}_{b} (period 3 in FIG. 7). Then, the output voltage of the secondary battery 34 is further increased to be equal to or higher than the B system second threshold Vₜₕ₂_{_{—}}_{b}, the switching circuit 35b is operated under the control of the switching controller 37 so that the power supply source of the B system S_{b} is switched from the main power supply circuit 32 to the secondary battery 34. With this, the state of electric power supply to the controller unit 20 returns to a state as illustrated in FIG. 5. Thereafter, the state as illustrated in FIG. 5 is kept while the output voltage of the secondary battery 34 does not reach the A system second threshold Vₜₕ₂_{_{—}}ₐ (period 2 in FIG. 7).

Then, the output voltage of the secondary battery 34 is further increased to be equal to or higher than the A system second threshold Vₜₕ₂_{_{—}}ₐ, the switching circuit 35a is operated under control by the switching controller 37 so that the power supply source of the A system Sₐ is switched from the main power supply circuit 32 to the secondary battery 34. With this, the state of electric power supply to the controller unit 20 returns to a state as illustrated in FIG. 4. Thereafter, the output voltage of the secondary battery 34 gradually lowers with the lowering of the SOC thereof due to discharge. However, the state as illustrated in FIG. 4 is kept until the output voltage of the secondary battery 34 becomes equal to or lower than the A system first threshold Vₜₕ₁_{_{—}}ₐ (period 1 in FIG. 7), again.

The B system second threshold Vₜₕ₂_{_{—}}_{b} is set to a value with which electric power supply from the secondary battery 34 is guaranteed to be continued for the B system set time ΔT_{b} after the power supply source of the B system S_{b} is switched from the main power supply circuit 32 to the secondary battery 34 and the electric power supply from the secondary battery 34 is started. Specifically, the B system second threshold Vₜₕ₂_{_{—}}_{b} is set such that the output voltage of the secondary battery 34, when the B system set time ΔT_{b} has passed, without charging of the secondary battery 34, after the output voltage of the secondary battery 34 becomes equal to or higher than the B system second threshold Vₜₕ₂_{_{—}}_{b} and the power supply source of the B system S_{b} is switched from the main power supply circuit 32 to the secondary battery 34, becomes higher than the B system first threshold Vₜₕ₁_{_{—}}_{b}.

To be more specific, when the B system set time ΔT_{b} has passed from the start of electric power supply from the secondary battery 34, the output voltage of the secondary battery 34 lowers with the lowering of the SOC thereof due to discharge of the secondary battery 34. A lowering amount of the output voltage of the secondary battery 34 during the B system set time ΔT_{b} is assumed to be a voltage drop amount ΔV_{b}. As the B system second threshold Vₜₕ₂_{_{—}}_{b}, a value that is higher than a value obtained by adding the voltage drop amount ΔV_{b} to the B system first threshold Vₜₕ₁_{_{—}}_{b} (Vₜₕ₁_{_{—}}_{b}+ΔV_{b}) is selected. Specifically, the B system second threshold Vₜₕ₂_{_{—}}_{b} is selected such that the difference ΔVₜₕ_{_{—}}_{b} between the B system first threshold Vₜₕ₁_{_{—}}_{b} and the B system second threshold Vₜₕ₂_{_{—}}_{b} is higher than the voltage drop amount ΔV_{b}.

Furthermore, the A system second threshold Vₜₕ₂_{_{—}}ₐ is set to a value with which electric power supply from the secondary battery 34 is guaranteed to be continued during the A system set time ΔTₐ after the power supply source of the A system Sₐ is switched from the main power supply circuit 32 to the secondary battery 34 and the electric power supply from the secondary battery 34 is started. Specifically, the A system second threshold Vₜₕ₂_{_{—}}ₐ is set such that the output voltage of the secondary battery 34, when the A system set time ΔTₐ has passed, without charging of the secondary battery 34, after the output voltage of the secondary battery 34 becomes equal to or higher than the A system second threshold Vₜₕ₂_{_{—}}ₐ and the power supply source of the A system Sₐ is switched from the main power supply circuit 32 to the secondary battery 34, becomes higher than the A system first threshold Vₜₕ₁_{_{—}}ₐ.

To be more specific, when the A system set time ΔTₐ has passed from the start of electric power supply from the secondary battery 34, the output voltage of the secondary battery 34 lowers with the lowering of the SOC thereof due to discharge of the secondary battery 34. A lowering amount of the output voltage of the secondary battery 34 during the A system set time ΔTₐ is assumed to be a voltage drop amount ΔVₐ. As the A system second threshold Vₜₕ₂_{_{—}}ₐ, a value that is higher than a value obtained by adding the voltage drop amount ΔVₐ to the A system first threshold Vₜₕ₁_{_{—}}ₐ (Vₜₕ₁_{_{—}}ₐ+ΔVₐ) is selected. Specifically, the A system second threshold Vₜₕ₂_{_{—}}ₐ is selected such that the difference ΔVₜₕ_{_{—}}ₐ between the A system first threshold Vₜₕ₁_{_{—}}ₐ and the A system second threshold Vₜₕ₂_{_{—}}ₐ is higher than the voltage drop amount ΔVₐ.

The A system set time ΔTₐ and the B system set time ΔT_{b} are previously set in accordance with a set input by a user using an operation panel (not illustrated) included in the image forming apparatus 1, for example. Specifically, if a user performs the set input for setting an A system set time ΔTₐ and a B system set time ΔT_{b} using the operation panel, the controller unit 20 receives the set input so as to set the A system set time ΔTₐ and the B system set time ΔT_{b}. Furthermore, the controller unit 20 selects optimum values of the A system second threshold Vₜₕ₂_{_{—}}ₐ and the B system second threshold Vₜₕ₂_{_{—}}_{b} using the A system set time ΔTₐ and the B system set time ΔT_{b} that have been previously set.

Hereinafter, a specific method in which the controller unit 20 selects an optimum value of the B system second threshold Vₜₕ₂_{_{—}}_{b} is described with reference to FIG. 8. It is to be noted that an optimum value of the A system second threshold Vₜₕ₂_{_{—}}ₐ can be also selected in the same manner as the following description.

FIG. 8 is a graph illustrating an example of a discharge characteristic of the secondary battery 34. As illustrated in FIG. 8, a common discharge characteristic of the secondary battery 34 is such a downwise characteristic that an output voltage [V] of the secondary battery 34 is decreased as a discharge amount [mAh] thereof is increased. The voltage drop amount ΔV_{b} of the secondary battery 34 during the B system set time ΔT_{b} can be calculated based on a discharge amount ΔC_{b} of the secondary battery 34 during the B system set time ΔT_{b} using the discharge characteristic of the secondary battery 34. On a graph expressing the discharge characteristic of the secondary battery 34, a voltage drop amount corresponding to a discharge amount when the secondary battery 34 has discharged by ΔC_{b} and the output voltage has reached the B system first threshold Vₜₕ₁_{_{—}}_{b} corresponds to a voltage drop amount ΔV_{b} of the secondary battery 34 during the B system set time ΔT_{b}.

The discharge amount ΔC_{b} of the secondary battery 34 during the B system set time ΔT_{b} can be obtained in the following manner based on an electric power consumption amount (B system) P_{b} of the controller unit 20 per unit time in the energy saving mode, the B system set time ΔT_{b}, and the supply voltage V_{b} (for example, 1.1 V) of the B system S_{b}.

ΔC_{b}═P_{b}×ΔT_{b}/V_{b}

The electric power consumption amount P_{b} of the controller unit 20 per unit time in the energy saving mode is a value estimated at a design stage. Because the number of devices to which power supply is supplied is limited in the energy saving mode, the estimation can be performed with relatively high accuracy.

It is to be noted that the power supply source of the B system S_{b} has been already switched from the main power supply circuit 32 to the secondary battery 34 at a time at which the power supply source of the A system Sₐ is switched from the main power supply circuit 32 to the secondary battery 34. Accordingly, when a discharge amount ΔCₐ of the secondary battery 34 during the A system set time ΔTₐ is obtained, not only the electric power consumption in the A system Sₐ but also that in the B system S_{b} are required to be taken into consideration. The discharge amount ΔCₐ of the secondary battery 34 during the A system set time ΔTₐ can be obtained in the following manner based on the above-described P_{b} and V_{b}, an electric power consumption amount (A system) Pₐ of the controller unit 20 per unit time in the energy saving mode, the A system set time ΔTₐ, the supply voltage Vₐ (for example, 3.3 V) of the A system Sₐ.

ΔCₐ=(Pₐ×ΔTₐ/Vₐ)+(P_{b}×ΔTₐ/V_{b})

Furthermore, the voltage drop amount ΔVₐ of the secondary battery 34 during the A system set time ΔTₐ can be obtained based on the discharge amount ΔCₐ of the secondary battery 34 during the A system set time ΔTₐ and the discharge characteristic of the secondary battery 34.

As the B system second threshold Vₜₕ₂_{_{—}}_{b}, a value that is higher than a value obtained by adding the voltage drop amount ΔV_{b} of the secondary battery 34 during the B system set time ΔT_{b} as obtained in the above-described manner to the B system first threshold Vₜₕ₁_{_{—}}_{b} (Vₜₕ₁_{_{—}}_{b}+ΔV_{b}) is selected as described above. In the same manner, as the A system second threshold Vₜₕ₂_{_{—}}ₐ, a value that is higher than a value obtained by adding the voltage drop amount ΔVₐ of the secondary battery 34 during the A system set time ΔTₐ to the A system first threshold Vₜₕ₁_{_{—}}ₐ (Vₜₕ₁_{_{—}}ₐ+ΔTₐ) is selected.

The A system second threshold Vₜₕ₂_{_{—}}ₐ and the B system second threshold Vₜₕ₂_{_{—}}_{b} as selected in the above-described manner are notified to the switching controller 37 of the power supply unit 30 from the controller unit 20. The switching controller 37 holds the A system second threshold Vₜₕ₂_{_{—}}ₐ and the B system second threshold Vₜₕ₂_{_{—}}_{b} received from the controller unit 20 so as to control the switching circuits 35a and 35b using the A system second threshold Vₜₕ₂_{_{—}}ₐ and the B system second threshold Vₜₕ₂_{_{—}}_{b}.

As described above, the A system second threshold Vₜₕ₂_{_{—}}ₐ and the B system second threshold Vₜₕ₂_{_{—}}_{b} are variable values selected using the A system set time ΔTₐ and the B system set time ΔT_{b} that are set in accordance with a set input by a user and the discharge characteristic of the secondary battery 34, for example. Accordingly, if a user performs the set input in the light of an actual usage condition of the image forming apparatus 1, the A system second threshold Vₜₕ₂_{_{—}}ₐ and the B system second threshold Vₜₕ₂_{_{—}}_{b} in response to the actual usage condition of the image forming apparatus 1 are selected. The A system set time ΔTₐ and the B system set time ΔT_{b} may be set to an average length of a time during which the user does not use the image forming apparatus 1, that is, an average length of duration in the energy saving mode, for example. The time during which the user does not use the image forming apparatus 1 is made different depending on users. Therefore, a function of measuring the duration in the energy saving mode, obtaining an average value thereof, and setting the obtained average value as the A system second threshold Vₜₕ₂_{_{—}}ₐ and the B system second threshold Vₜₕ₂_{_{—}}_{b} may be added to the image forming apparatus 1.

Furthermore, it is known that the discharge characteristic of the secondary battery 34 changes depending on a temperature of the secondary battery 34. Accordingly, a temperature sensor that detects an ambient temperature of the secondary battery 34 is provided as the sensor 26 of the controller unit 20. In addition, a plurality of discharge characteristics corresponding to a plurality of temperatures are previously held as information and the voltage drop amount ΔVₐ and the voltage drop amount ΔV_{b} of the secondary battery 34 are obtained using a discharge characteristic corresponding to a temperature detected by the temperature sensor so as to select the A system second threshold Vₜₕ₂_{_{—}}ₐ and the B system second threshold Vₜₕ₂_{_{—}}_{b}. Thus, the control with higher accuracy is possible.

Furthermore, the discharge characteristic of the secondary battery 34 also changes depending on a discharge current of the secondary battery 34. In general, as the discharge current is larger, an influence by an internal resistance of the secondary battery 34 is larger and a lowering degree of the output voltage of the secondary battery 34 is larger. Accordingly, intensities of the discharge currents in the A system Sₐ and the B system S_{b} are previously obtained roughly, and the A system second threshold Vₜₕ₂_{_{—}}ₐ and the B system second threshold Vₜₕ₂_{_{—}}_{b} are selected using the discharge characteristic of the secondary battery 34 corresponding to the intensity of the discharge current of the A system Sₐ and the discharge characteristic corresponding to the intensity of the discharge current of the B system S_{b}, respectively. Thus, the control with higher accuracy is possible.

Furthermore, errors of the A system second threshold Vₜₕ₂_{_{—}}ₐ and the B system second threshold Vₜₕ₂_{_{—}}_{b} are generated depending on an actual operation environment of the image forming apparatus 1. However, the errors can be made smaller with learning. To be more specific, every time the switching controller 37 of the power supply unit 30 operates the switching circuits 35a and 35b so as to switch the power supply source, the switching controller 37 feeds back a switching timing signal indicating the switching timing to the controller unit 20. The controller unit 20 calculates an actual elapsed time until the power supply source is switched from the secondary battery 34 to the main power supply circuit 32 after the power supply source has been switched from the main power supply circuit 32 to the secondary battery 34 based on the switching timing signal for each of the A system Sₐ and the B system S_{b}. Then, the controller unit 20 updates the A system second threshold Vₜₕ₂_{_{—}}ₐ and the B system second threshold Vₜₕ₂_{_{—}}_{b} such that differences between the A system set time ΔTₐ and the B system set time ΔT_{b} and the calculated elapsed time are smaller. For example, if the calculated elapsed time is longer than the A system set time ΔTₐ and/or the B system set time ΔT_{b}, the A system second threshold Vₜₕ₂_{_{—}}ₐ and/or the B system second threshold Vₜₕ₂_{_{—}}_{b} is/are updated to value(s) that is/are lower than the present value(s). On the other hand, if the calculated elapsed time is shorter than the A system set time ΔTₐ and/or the B system set time ΔT_{b}, the A system second threshold Vₜₕ₂_{_{—}}ₐ and/or the B system second threshold Vₜₕ₂_{_{—}}_{b} is/are updated to value(s) that is/are higher than the present value(s). With this, errors of the A system set time ΔTₐ and the B system set time ΔT_{b} in accordance with the operation environment or the like of the image forming apparatus 1 can be made smaller. Thus, the control with higher accuracy is possible.

As described in detailed above with specific examples, in the image forming apparatus 1 according to the embodiment, after the power supply source to the controller unit 20 has been switched from the main power supply circuit 32 to the secondary battery 34 in the energy saving mode, if the output voltage of the secondary battery 34 becomes equal to or lower than the first threshold (A system first threshold Vₜₕ₁_{_{—}}ₐ and B system first threshold Vₜₕ₁_{_{—}}_{b}), the power supply source to the controller unit 20 is switched from the secondary battery 34 to the main power supply circuit 32. Thereafter, if the secondary battery 34 is charged with electric power generated by the power generator 33, the SOC thereof is recovered, and the output voltage of the secondary battery 34 becomes equal to or higher than the second threshold (A system second threshold Vₜₕ₂_{_{—}}ₐ and B system second threshold Vₜₕ₂_{_{—}}_{b}), the power supply source to the controller unit 20 is switched from the main power supply circuit 32 to the secondary battery 34. As the second threshold (A system second threshold Vₜₕ₂_{_{—}}ₐ and B system second threshold Vₜₕ₂_{_{—}}_{b}) for switching the power supply source to the controller unit 20 from the main power supply circuit 32 to the secondary battery 34, a value with which the output voltage of the secondary battery 34, when the set time (A system set time ΔTₐ and B system set time ΔT_{b}) has passed, without charging of the secondary battery 34, after the power supply source to the controller unit 20 is switched from the main power supply circuit 32 to the secondary battery 34, becomes higher than the first threshold (A system first threshold Vₜₕ₁_{_{—}}ₐ and B system first threshold Vₜₕ₁_{_{—}}_{b}) is used. Therefore, with the image forming apparatus 1 according to the embodiment, a time during which electric power is supplied from the secondary battery 34 to the controller unit 20 in the energy saving mode is ensured sufficiently while effectively preventing frequent switching of the power supply sources to the controller unit 20, thereby appropriately reducing electric power consumption.

The specific embodiment of the invention has been described. However, the invention is not limited to the above-described embodiment as it is and can be embodied by varying constituent components in a range without departing from a scope of the invention at an execution stage. For example, the configuration and the operation of the image forming apparatus 1 according to the embodiment are merely examples and can be varied variously in accordance with an intended use or object.

The image forming apparatus 1 described above may be configured to have a hardware configuration using a normal computer including a control device, such as a central processing unit (CPU); a storage device, such as a read only memory (ROM) or a random access memory (RAM); and an external storage device, such as a hard disk drive (HDD) or a compact disc (CD)-drive.

The above processing performed by the image forming apparatus 1 may be provided as a computer program by being recorded in a computer-readable recording medium, such as a CD-ROM, a flexible disk (FD), a CD-R, or a digital versatile disk (DVD), in a computer-installable or a computer-executable file format.

The computer program performed may be stored in a computer connected to a network, such as the Internet, so as to be provided by being downloaded via the network. The computer program executed by the image forming apparatus 1 may be provided or distributed via a network, such as the Internet.

The present invention can achieve the effect of sufficiently ensuring time during which electric power is supplied from a secondary battery while effectively preventing frequent switching of power supply sources so as to reduce electric power consumption appropriately.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a main power supply configured to receive electric power from a commercial power supply;
a power generation unit configured to generate electric power with natural energy;
a secondary battery configured to serve as a power supply source while the electric power is not supplied from the main power supply, the secondary battery being charged with the electric power generated by the power generation unit;
a voltage detector configured to detect an output voltage of the secondary battery; and
a switching unit configured to switch the power supply source from the secondary battery to the main power supply when the output voltage becomes equal to or lower than a first threshold while the electric power is supplied from the secondary battery, and switch the power supply source from the main power supply to the secondary battery when the output voltage becomes equal to or higher than a second threshold that is higher than the first threshold while the electric power is supplied from the main power supply, wherein
the second threshold is set such that the output voltage, when the second battery has not been charged and a set time has passed after the power supply source is switched from the main power supply to the secondary battery, is higher than the first threshold.

2. The image forming apparatus according to claim 1, wherein the second threshold is larger than a value obtained by adding a voltage drop amount of the secondary battery during the set time to the first threshold, the voltage drop amount being calculated from a discharge amount of the secondary battery during the set time and a discharge characteristic of the secondary battery.

3. The image forming apparatus according to claim 2, wherein the discharge amount of the secondary battery during the set time is calculated by
ΔC=P×ΔT/V
where P is an electric power consumption per unit time, ΔT is the set time, V is a supply voltage, and ΔC is the discharge amount of the secondary battery during the set time.

4. The image forming apparatus according to claim 2, further comprising a temperature detector configured to detect an ambient temperature of the secondary battery, wherein
the voltage drop amount of the secondary battery during the set time is calculated using a discharge characteristic of the secondary battery at the ambient temperature.

5. The image forming apparatus according to claim 1, further comprising a plurality of power supply systems each configured to supply a different voltage, wherein
the switching unit is provided for each of the power supply systems to switch the power supply source to the corresponding voltage,
each of the first threshold and the second threshold is different among the power supply systems, and
the set time is set to a value that is different among the power supply systems.

6. The image forming apparatus according to claim 1, further comprising a receiving unit configured to receive an input by a user for setting the set time.

7. The image forming apparatus according to claim 1, further comprising:
a calculating unit configured to calculate an elapsed time from when the power supply source is switched from the main power supply to the secondary battery to when the power supply source is switched from the secondary battery to the main power supply; and
an updating unit configured to update the second threshold so that a difference between the set time and the elapsed time is made smaller.

8. The image forming apparatus according to claim 1, wherein the power generation unit is a solar cell.

9. The image forming apparatus according to claim 1, wherein the power generation unit is a thermoelectric conversion element.

10. A power supply control method performed in an image forming apparatus that includes a main power supply configured to receive electric power from a commercial power supply, a power generation unit configured to generate electric power with natural energy, and a secondary battery configured to serve as a power supply source while the electric power is not supplied from the main power supply, the secondary battery being charged with the electric power generated by the power generation unit, the power supply control method comprising:
detecting an output voltage of the secondary battery;
switching the power supply source from the secondary battery to the main power supply when the output voltage becomes equal to or lower than a first threshold while the electric power is supplied from the secondary battery;
switching the power supply source from the main power supply to the secondary battery when the output voltage becomes equal to or higher than a second threshold that is higher than the first threshold while the electric power is supplied from the main power supply, wherein
the second threshold is set such that the output voltage, when the second battery has not been charged and a set time has passed after the power supply source is switched from the main power supply to the secondary battery, is higher than the first threshold.

11. A non-transitory computer-readable storage medium with an executable program stored thereon and performed in an image forming apparatus that includes a main power supply configured to receive electric power from a commercial power supply, a power generation unit configured to generate electric power with natural energy, and a secondary battery configured to serve as a power supply source while the electric power is not supplied from the main power supply, the secondary battery being charged with the electric power generated by the power generation unit, wherein the program instructs a processor of the image forming apparatus to perform:
detecting an output voltage of the secondary battery;
switching the power supply source from the secondary battery to the main power supply when the output voltage becomes equal to or lower than a first threshold while the electric power is supplied from the secondary battery;
switching the power supply source from the main power supply to the secondary battery when the output voltage becomes equal to or higher than a second threshold that is higher than the first threshold while the electric power is supplied from the main power supply, wherein
the second threshold is set such that the output voltage, when the second battery has not been charged and a set time has passed after the power supply source is switched from the main power supply to the secondary battery, is higher than the first threshold.
